(19) United States
(12) Patent Application Publication
(10) Pub. No.: US 2025/0158264 A1
(43) Pub. Date: May 15, 2025

(54) DIELECTRIC WAVEGUIDE CABLE AND TERMINAL STRUCTURE OF DIELECTRIC WAVEGUIDE CABLE

(71) Applicant: Proterial, Ltd., Tokyo (JP)

(72) Inventors: Takahiro SUGIYAMA, Tokyo (JP); Kazuhiro ABE, Tokyo (JP)

(21) Appl. No.: 18/937,815

(22) Filed: Nov. 5, 2024

(30) Foreign Application Priority Data
Nov. 13, 2023 (JP) 2023-192699

(51) Int. Cl. H01P 3/16; H01P 3/127; H01P 5/08

(52) U.S. Cl. CPC H01P 3/16; H01P 3/127; H01P 5/087

(57) ABSTRACT

A dielectric waveguide cable having a core made from a dielectric material and transmitting GHz-band electromagnetic waves by means of the core, in which a cavity extending along the cable longitudinal direction is formed at the center of the core in a cross-section perpendicular to the cable longitudinal direction, is provided.

### CROSS-REFERENCE TO RELATED APPLICATIONS

The present application is based on Japanese patent application No. 2023-192699 filed on Nov. 13, 2023, the entire contents of which are incorporated herein by reference.

### TECHNICAL FIELD

The present invention relates to a dielectric waveguide cable having a waveguide made from a dielectric material(s), and to a terminal structure of a dielectric waveguide cable.

### BACKGROUND TECHNOLOGY

Conventionally, dielectrics with a high dielectric constant and a low dielectric loss tangent have been used as signal transmission media for transmitting high-frequency signals such as millimeter waves. In the dielectric waveguide line described in Patent Literature 1, a resin such as PTFE (polytetrafluoroethylene) is used as a signal transmission medium. Also, Patent Literature 1 describes that the dielectric waveguide line consists of a dielectric waveguide line main body having a circular cross section and a dielectric waveguide line end(s) formed in a conical shape, and that a part of the dielectric waveguide line main body is mated with a mating hole provided in a connector.

### CITATION LIST

### Patent Literature

Patent Literature 1: WO2018-216636

### SUMMARY OF THE INVENTION

In recent years, dielectric waveguide cables capable of transmitting higher frequency signals over longer distances have been sought against the background of increasing speeds in mobile communications and other factors. To enable long-distance transmission of high-frequency signals, it is necessary to reduce transmission loss in dielectric waveguide cables. It is also important to suppress reflections at the ends of the dielectric waveguide cables. For the above reason, the object of the present invention is to provide a dielectric waveguide cable capable of reducing transmission loss and a terminal structure of a dielectric waveguide cable capable of suppressing reflection at the end of the dielectric waveguide cable.

To solve the above problem, the present invention provides dielectric waveguide cable, comprising a core composed of a dielectric material and configured to transmit GHz-band electromagnetic waves by means of the core, wherein a cavity extending along a cable longitudinal direction is formed at a center of the core in a cross-section perpendicular to the cable longitudinal direction.

Also, to solve the above problem, the present invention provides a terminal structure of a dielectric waveguide cable configured to transmit GHz-band electromagnetic waves by means of a core composed of a dielectric material, wherein a terminal member and a dielectric waveguide cable are arranged in line so that a central axis of the terminal member composed of a dielectric material having a conical portion coincides with a central axis of the dielectric waveguide cable, wherein the dielectric waveguide cable includes a cavity extending along a cable longitudinal direction at a center of the core in a cross-section perpendicular to the cable longitudinal direction, wherein the terminal member includes a shaft hole with a reduced inner diameter that decreases in diameter toward a tip of the conical portion, and wherein the cavity of the dielectric waveguide cable and the shaft hole of the terminal member are in communication with each other.

In addition, to solve the above problem, the present invention provides a terminal structure of dielectric waveguide cable configured to transmit GHz-band electromagnetic waves by a core composed of a dielectric material, wherein a terminal member and a dielectric waveguide cable are arranged in line so that a central axis of the terminal member composed of a dielectric material having a conical portion, coincides with the central axis of the dielectric waveguide cable, wherein the dielectric waveguide cable has a cavity extending along a cable longitudinal direction at a center of the core in a cross-section perpendicular to the cable longitudinal direction, and wherein at least one linear dielectric material having an outer diameter smaller than an inner diameter of the cavity is housed in the cavity at an end of a terminal member-side in the core.

### Effects of the Invention

According to the present invention, it is possible to provide a dielectric waveguide cable capable of reducing transmission loss and a terminal structure of a dielectric waveguide cable capable of suppressing reflection at the end of the dielectric waveguide cable.

### BRIEF DESCRIPTION OF DRAWINGS

FIG. 1A is a perspective view showing a configuration example of a dielectric waveguide cable according to an embodiment of the present invention.

FIG. 1B is a cross-sectional view taken along the line A-A of FIG. 1A.

FIG. 2A is a graph showing the results of analysis of the relationship between the inner/outer diameter ratio and transmission loss in a dielectric waveguide having a cavity at the center.

FIG. 2B is a cross-sectional view of the dielectric waveguide used in the analysis.

FIG. 3A is a graph showing the results of transmission loss measurement at a transmission frequency of 28 GHz for the dielectric waveguide cable according to the present embodiment and a dielectric waveguide cable in a comparative example.

FIG. 3B is a cross-sectional view of the dielectric waveguide cable in the comparative example.

FIG. 4 is a graph showing the results of S21 measurements at transmission frequencies from 21 GHz to 40 GHz for several dielectric waveguide cables of different cable lengths.

FIG. 5A and FIG. 5B are configuration diagrams showing a first example of a terminal structure of the dielectric waveguide cable.

FIG. 6A through FIG. 6C are configuration diagrams showing a second example of the terminal structure of the dielectric waveguide cable.

### DETAILED DESCRIPTION OF THE INVENTION

### Embodiment

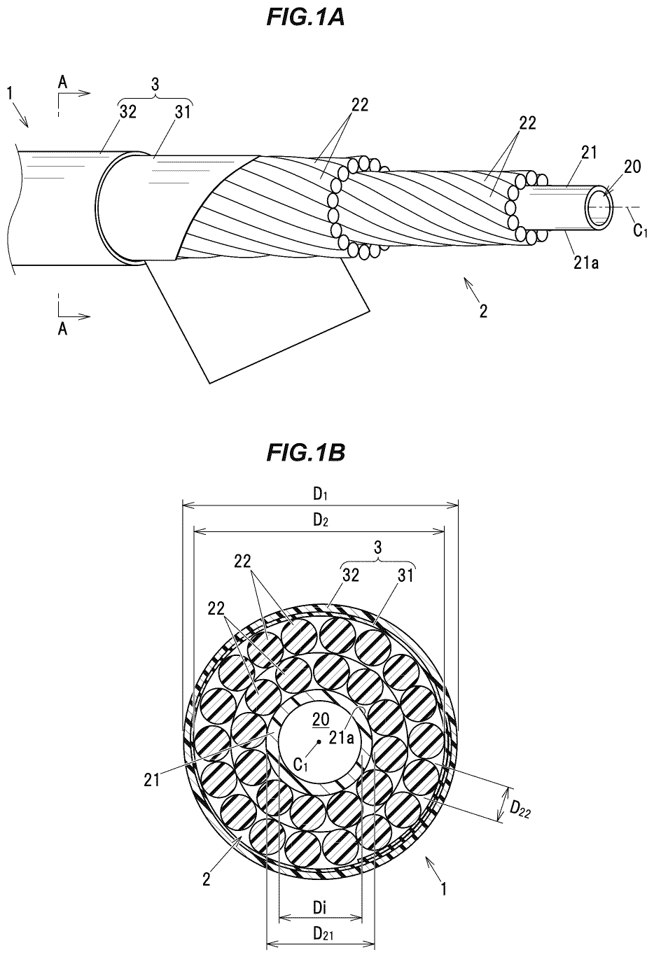

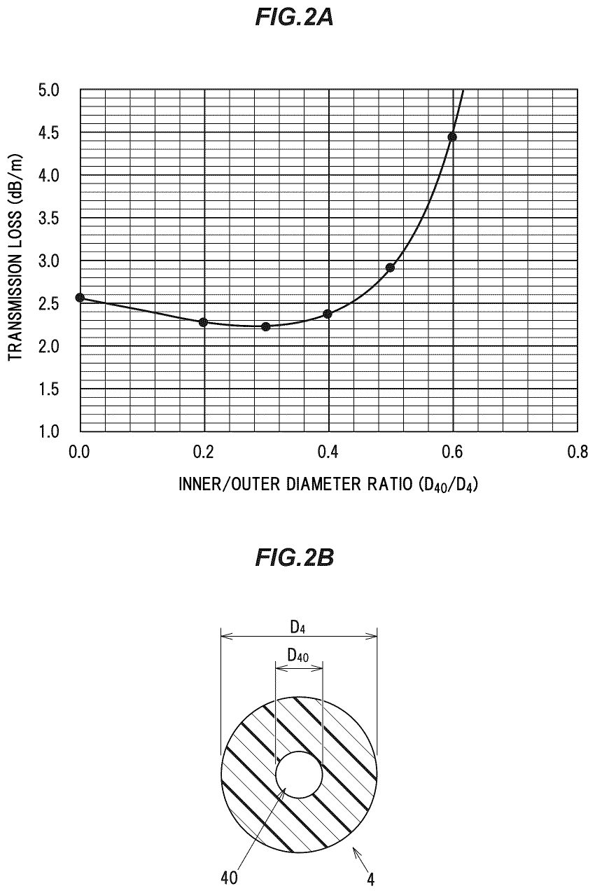

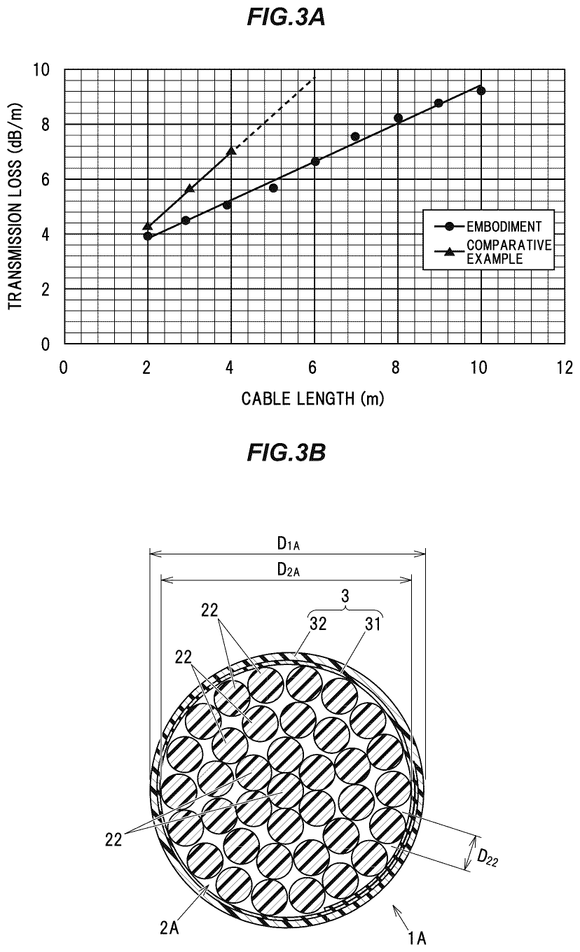

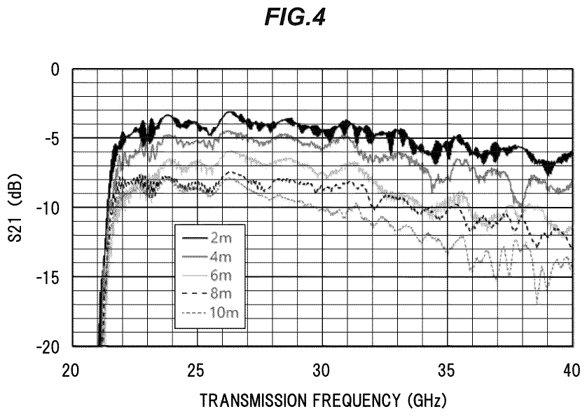

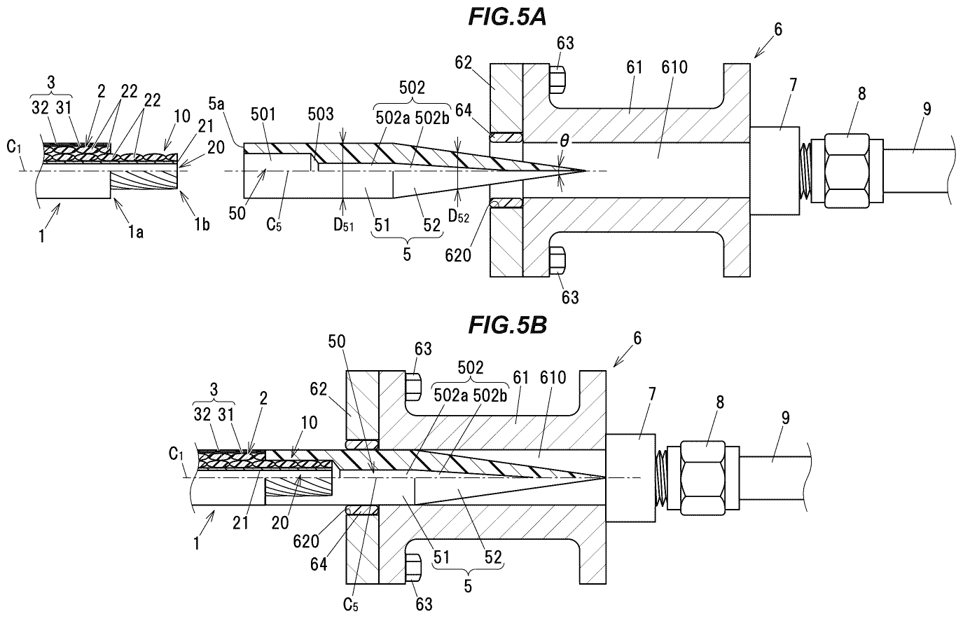

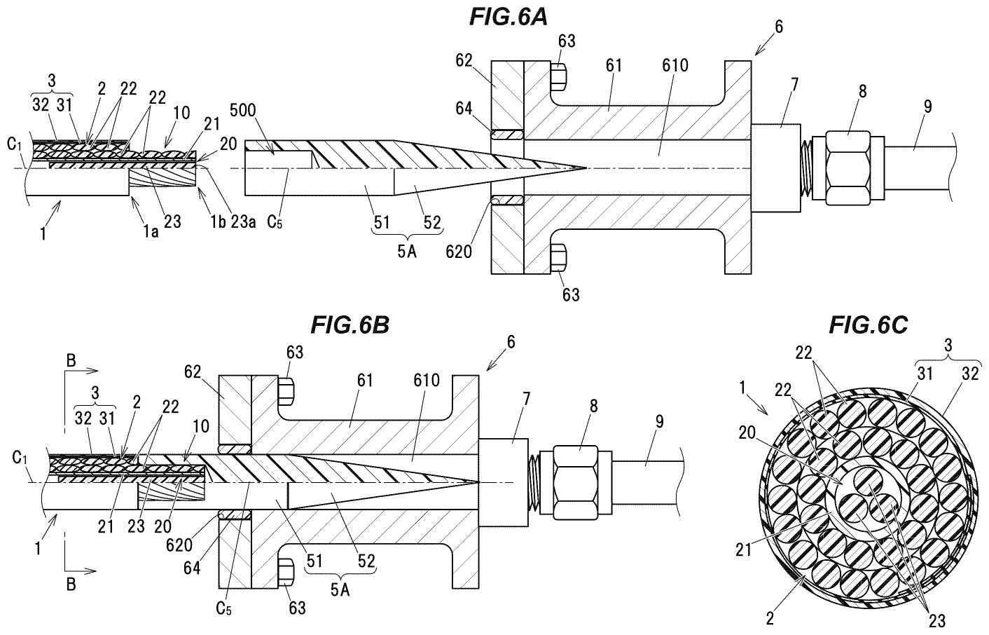

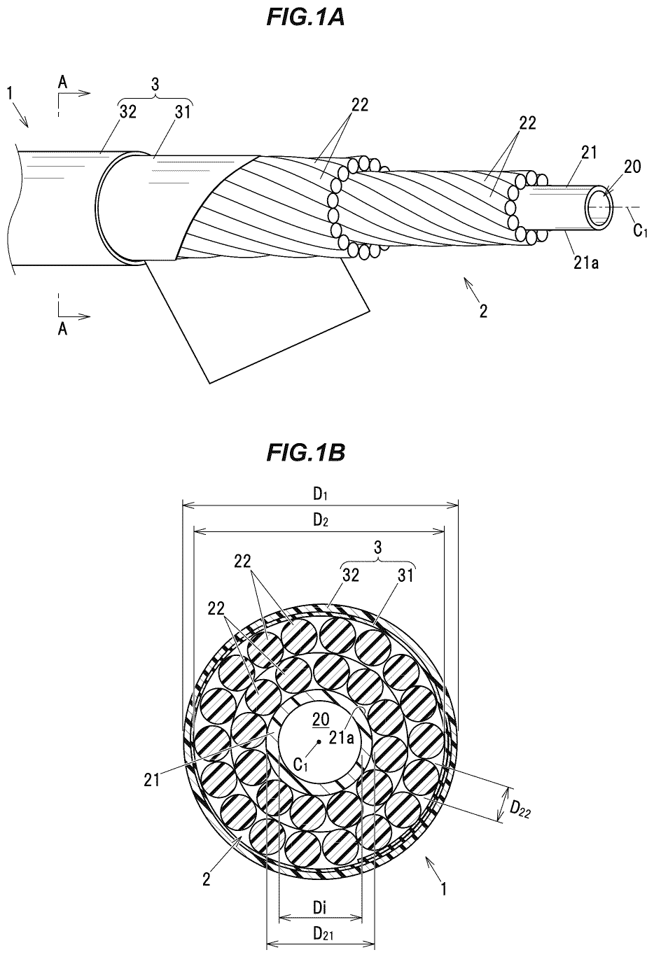

FIG. 1A is a perspective view showing a configuration example of a dielectric waveguide cable according to an embodiment of the present invention. FIG. 1B is a cross-sectional view taken along the line A-A of FIG. 1A. In FIG. 1A, the end of a dielectric waveguide cable 1 is shown in a stepped stripped state. In FIG. 1A and FIG. 1B, a central axis line C₁ of the dielectric waveguide cable 1 is shown as a single dotted line. Hereafter, the direction along the central axis line C₁ of the dielectric waveguide cable 1 is referred to as the cable longitudinal direction. FIG. 1B is a cross-sectional view of the dielectric waveguide cable 1 perpendicular to the cable longitudinal direction.

The dielectric waveguide cable 1 is composed of a core 2, which is a waveguide made from dielectric materials, and an outer coating 3 arranged around the periphery of the core 2, which transmits GHz-band electromagnetic waves by means of the core 2. The dielectric waveguide cable 1 according to the present embodiment is particularly suitable for transmitting electromagnetic waves in the range of 20 GHz to 100 GHz (20 GHz or more and 100 GHz or less) but can also be used for transmitting electromagnetic waves in the range of 100 GHz to 300 GHz (100 GHz or more and 300 GHz or less).

The dielectric materials that constitute the core 2 are made of resin whose dielectric tangent at the frequency of electromagnetic waves transmitted by the dielectric waveguide cable 1 is smaller than 1×10⁻³. Here, the dielectric loss tangent (also called tan δ, tangent delta, or tan delta) is an index that indicates the ratio of a portion of the energy that becomes heat when an alternating electric field is applied to a dielectric material, and the value of the dielectric loss tangent becomes smaller as the loss decreases. More specifically, any of fluororesin, for example, foamed fluororesin, polyethylene, foamed polyethylene, polypropylene, or foamed polypropylene may be used as the resin that constitutes the core 2.

At the center of the core 2 in a cross-section perpendicular to the cable longitudinal direction, a cavity 20 that extends along the cable longitudinal direction is formed. The cavity 20 is filled with air (atmosphere). Since the dielectric loss tangent of air is generally lower than that of resin, and the electromagnetic waves transmitted by means of the core 2 propagate especially at the center, the loss is reduced due to the presence of the cavity 20 at the center of the core 2.

As shown in FIG. 1B, when the cable outer diameter of the dielectric waveguide cable 1 is D₁ and the inner diameter of the cavity 20 is Di, the ratio of the inner diameter Di of the cavity 20 to the cable outer diameter D₁ (Di/D₁) is in the range of 20% to 40% (20% or more and 40% or less). If Di/D₁ is less than 20%, the sectional area of the cavity 20 in the cross-section perpendicular to the cable longitudinal direction becomes smaller, and the effect of loss reduction decreases. If Di/D₁ is larger than 40%, the thickness of the dielectric waveguide cable 1 outside the cavity 20 becomes thinner, which decreases the effect of confining electromagnetic waves inside the waveguide. As a result, electromagnetic waves radiate to the outside of the dielectric waveguide cable 1, causing larger losses. Therefore, the effect of loss suppression is greater when Di/D₁ is in the range of 20% to 40% (20% or more and 40% or less). The cable outer diameter D₁ of the dielectric waveguide cable 1 is 10.08 mm as an example, and the inner diameter Di of the cavity 20 is 3.00 mm as an example.

In the present embodiment, the core 2 is composed of a dielectric waveguide tube 21 and a plurality of dielectric waveguide wires (i.e., dielectric waveguide lines) 22 arranged around the dielectric waveguide tube 21. The dielectric waveguide tube 21 is a hollow tube having the cavity 20 formed at the center. The outer diameter D₂₁ of the dielectric waveguide tube 21 is 4.00 mm as an example. A plurality of dielectric waveguide wires 22 are twisted in a spiral shape at an angle with respect to the cable longitudinal direction. This configuration of the core 2 enhances the flexibility of the dielectric waveguide cable 1.

Both the dielectric waveguide tube 21 and the plurality of dielectric waveguide wires 22 are made of fluororesin having a dielectric loss tangent smaller than 1×10⁻³ at the frequency of electromagnetic waves transmitted by the dielectric waveguide cable 1. In order to maintain the shape of the dielectric waveguide tube 21, a resin material of the dielectric waveguide tube 21 should be harder than a resin material of the dielectric waveguide wires 22. In the present embodiment, the dielectric waveguide tube 21 is made of PTFE (polytetrafluoroethylene) and the dielectric waveguide wires 22 are made of FEP (tetrafluoroethylene hexafluoropropylene copolymer).

As shown in FIG. 1A and FIG. 1B, the core 2 consists of 30 dielectric waveguide wires 22 twisted in a spiral shape in a two-layer inner/outer structure around one dielectric waveguide tube 21 located at the center. Among the 30 dielectric waveguide wires, twelve dielectric waveguide wires 22 of the inner layer are arranged to contact the outer surface 21a of the dielectric waveguide tube 21, and eighteen dielectric waveguide wires 22 of the outer layer are arranged on the outer surface of the twelve dielectric waveguide wires 22 of the inner layer. In the present embodiment, as shown in FIG. 1A, the direction of helix winding of the twelve dielectric waveguide wires 22 of the inner layer is the same as that of the eighteen dielectric waveguide wires 22 of the outer layer. However, the winding directions of the plurality of dielectric waveguide wires 22 in the inner and outer layers may be opposite. When the helix winding direction is the same in the inner and outer layers, the dielectric waveguide cable 1 is easier to bend. When the helix winding directions are opposite in the inner and outer layers, the twisting of the plurality of dielectric waveguide wires 22 is less likely to loosen, and therefore, the transmitted electromagnetic waves can be confined inside the waveguide more effectively.

Each of the dielectric waveguide wire 22 has a circular cross-section perpendicular to the longitudinal direction and its outer diameter D₂₂ is, for example, 1.33 mm. A diameter D₂ of the core 2 is obtained as the sum of the outer diameter D₂₁ of the dielectric waveguide tube 21 and the outer diameter D₂₂ of the plurality of dielectric waveguide wires 22. The diameter D₂ of the core 2 is obtained as the outer diameter D₂₁ of the dielectric waveguide tube 21 plus the outer diameter D₂₂ of four dielectric waveguide wires 22. As an example, if the outer diameter D₂₁ of the dielectric waveguide tube 21 is 4.00 mm and the outer diameter D₂₂ of the dielectric waveguide wire 22 is 1.33 mm, the diameter D₂ of the core 2 is 9.32 mm. The ratio of the inner diameter Di of the cavity 20 to the diameter D₂ of the core 2 (Di/D₂) should be within the range of Di/D₂ described above (i.e., 20% or more and 40% or less). As an example, if the inner diameter Di of the cavity 20 of the dielectric waveguide tube 21 is 3.00 mm and the diameter D₂ of the core 2 is 9.32 mm, this ratio is about 32%.

An outer coating 3 is composed of a strip of binder tape 31 wrapped around the periphery of an assembly of a plurality (30 in this embodiment) of the dielectric waveguide wires 22, and a sheath 32 that covers the binder tape 31. The binder tape 31 is spirally wound around the core 2 so that portions of the tape overlap in the width direction. The binder tape 31 prevents the plurality of dielectric waveguide wires 22 from being scattered during the manufacturing process of the dielectric waveguide cable 1 or other occasions. The sheath 32 protects the core 2 and the binder tape 31. The sheath 32 is formed by extrusion molding around the circumference of the binder tape 31. The binder tape 31 is interposed between the sheath 32 and the core 2 to facilitate the formation of the sheath 32 and to enhance the bendability of the dielectric waveguide cable 1. Additionally, the outer coating 3 may be composed of at least one of the binder tape 31 and the sheath 32.

The materials of the binder tape 31 and the sheath 32 may have a higher value of dielectric dissipation factor than those of the dielectric waveguide tube 21 and the dielectric waveguide wire 22, but it is desirable that they be stronger than the materials of the dielectric waveguide tube 21 and the dielectric waveguide wire 22. Electromagnetic waves transmitted by the dielectric waveguide cable 1 propagate mainly through the core 2, but some may propagate through the binder tape 31 and sheath 32. The binder tape 31 consists of a sealing tape made of fluororesin such as PTFE, for example. It is favorable that the sheath 32 be made of a fluororesin such as FEP, for example, and be made of a material that is particularly resistant to abrasion and tear. The thickness of the binder tape 31 is, for example, from 0.07 mm to 0.09 mm (0.07 mm or more and 0.09 mm or less), and the thickness of the sheath 32 is, for example, from 0.25 mm to 0.35 mm (0.25 mm or more and 0.35 mm or less).

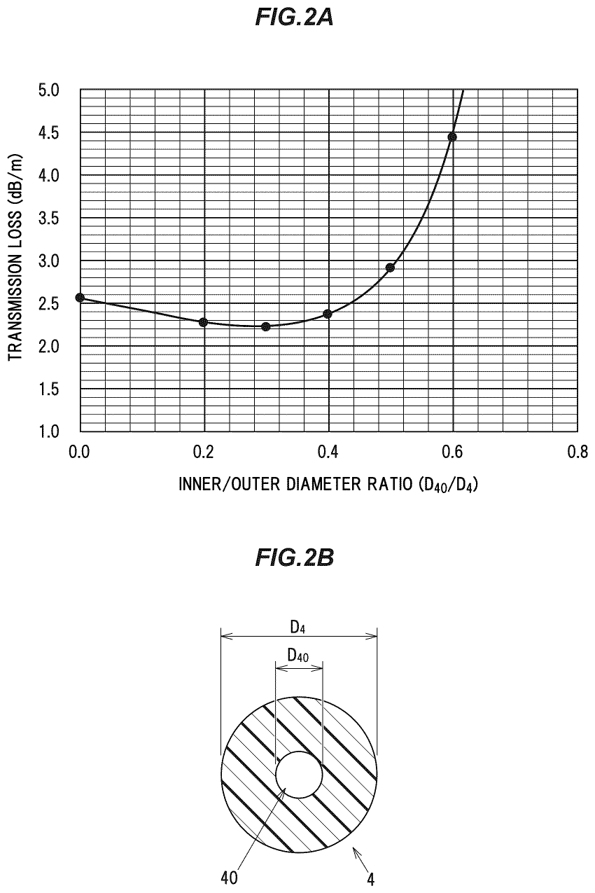

FIG. 2A shows the results of analysis of the relationship between the inner/outer diameter ratio and transmission loss in a dielectric waveguide with a cavity at the center. In this analysis, a dielectric waveguide 4 with a cavity 40 at the center was used, as shown in FIG. 2B, and the transmission loss per meter of length of the dielectric waveguide 4 was analyzed for multiple samples with different inner diameters D₄₀ of the cavity 40. The outer diameter D₄ of dielectric waveguide 4 was 10 mm, and FEP with a dielectric dissipation factor of 3×10⁻⁴ was used as a material of dielectric waveguide 4. The vertical axis of the graph is the transmission loss (dB/m) when 28 GHz electromagnetic waves are transmitted by the dielectric waveguide 4, and the horizontal axis of the graph is the ratio of the inner diameter to the outer diameter of the dielectric waveguide 4, indicated by D₄₀/D₄. A sample with a horizontal axis value of 0 is a sample with a solid medium structure in which the cavity 40 is not formed.

As shown in this graph, the transmission loss of dielectric waveguide 4 is as small as 2.4 dB/m or less when the inner/outer diameter ratio is in the range of 0.2 to 0.4, and the transmission loss is smallest when the inner/outer diameter ratio is 0.3. Additionally, when the inner/outer diameter ratio is 0.3 (D₄₀ is 3 mm), the transmission loss is improved by 0.34 dB/m compared to the case where the cavity 40 is not formed. Thus, by adjusting the ratio of the inner diameter D₄₀ to the outer diameter D₄ to an appropriate value, the dielectric waveguide 4 with the cavity 40 at the center can reduce the transmission loss better than the case where the cavity 40 is not formed.

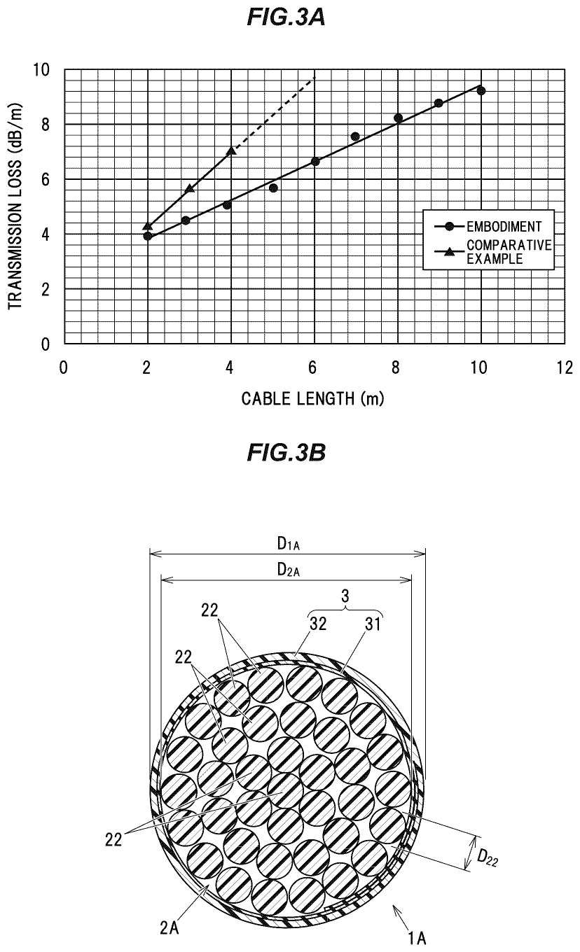

FIG. 3A shows the results of transmission loss measurements at a transmission frequency of 28 GHz for the dielectric waveguide cable 1 according to the present embodiment and a dielectric waveguide cable 1A according to the comparative example shown in FIG. 3B. A core 2A of the dielectric waveguide cable 1A according to the comparative example is configured by a total of 37 dielectric waveguide wires 22, with seven dielectric waveguide wires 22 arranged at the center instead of the dielectric waveguide tube 21 of the dielectric waveguide cable 1 according to the present embodiment. The outer diameter D1A of the dielectric waveguide cable 1A, the diameter D_{2A} of the core 2A and the outer diameter D₂₂ of the dielectric waveguide wire 22 in the dielectric waveguide cable 1A are the same as the outer diameter D₁, the diameter D₂ of the core 2 and the outer diameter D₂₂ of the dielectric waveguide wire 22 according to the present embodiment.

As shown in the graph in FIG. 3A, the dielectric waveguide cable 1 according to the present embodiment has a reduced transmission loss due to the presence of the cavity 20 at the center of the core 2, compared to the dielectric waveguide cable 1A according to the comparative example.

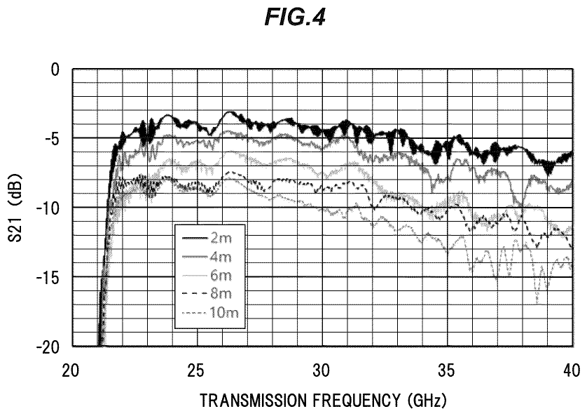

FIG. 4 shows the measurement results of S21 (a transmission coefficient from an input end to an output end) for transmission frequencies from 21 GHz to 40 GHz for the dielectric waveguide cables 1 with cable lengths of 2 m, 4 m, 6 m, 8 m and 10 m. As shown in FIG. 4, the longer the cable length and the higher the transmission frequency, the dielectric waveguide cable 1 tends to have a smaller S21 and a higher transmission loss, but on the whole, the transmission loss is kept small.

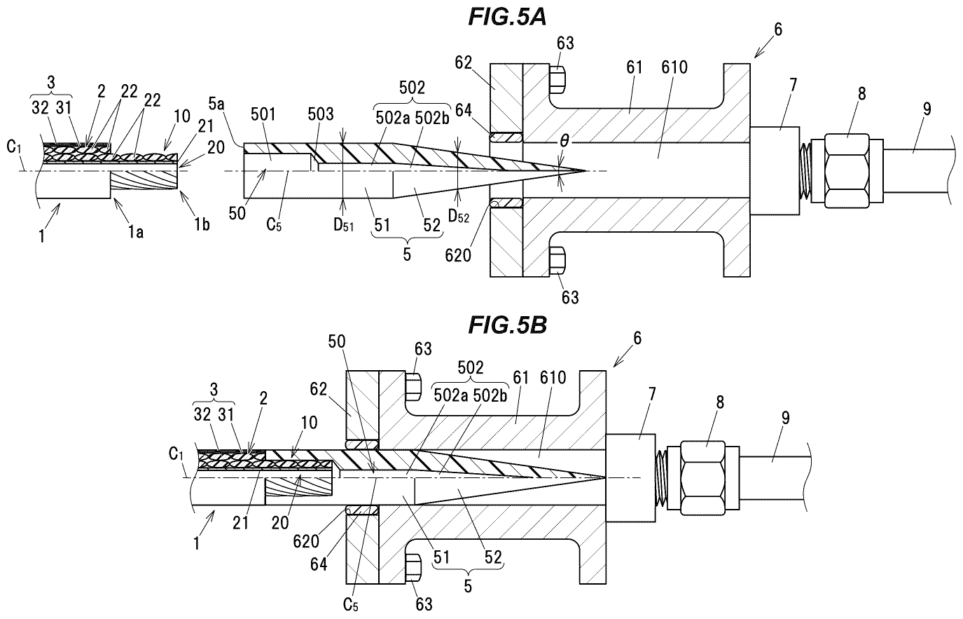

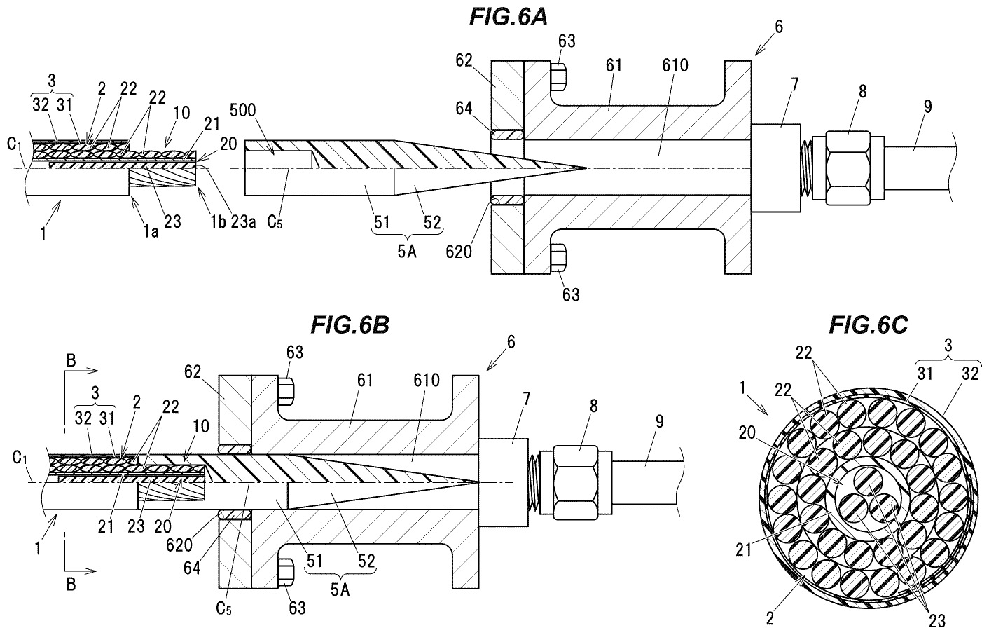

Next, two examples of the terminal structure of the dielectric waveguide cable 1 are described with reference to FIG. 5 and FIG. 6.

FIG. 5A and FIG. 5B are configuration diagrams showing a first example of the terminal structure of the dielectric waveguide cable 1. In the first configuration example, the dielectric waveguide cable 1 is connected to a connector 6 via a hollow terminal member 5. A coaxial waveguide conversion section 7 is attached to the connector 6, and a coaxial cable 9 is connected to the coaxial waveguide conversion section 7 via a coaxial connector 8.

In FIG. 5A, the dielectric waveguide cable 1, the terminal member 5, and the connector 6 are shown spaced apart in the axial direction, and in FIG. 5B, the dielectric waveguide cable 1, the terminal member 5, and the connector 6 are shown assembled. The dielectric waveguide cable 1 and the terminal member 5 are arranged in line in the axial direction so that the center axis C₁ of the dielectric waveguide cable 1 and the center axis C₅ of the terminal member 5 are aligned. In FIG. 5A and FIG. 5B, the cross-section view of the dielectric waveguide cable 1 and the terminal member 5 is shown above the central axis lines C₁ and C₅, and the external appearance of the dielectric waveguide cable 1 and the terminal member 5 is shown below the central axis lines C₁ and C₅.

At an end of the dielectric waveguide cable 1 on the connector 6 side, the eighteen dielectric waveguide wires 22 forming the outer layer are cut at a first end face 1a together with the binder tape 31 and the sheath 32 covering them, and the twelve dielectric waveguide wires 22 forming the inner layer are cut together with the dielectric waveguide tube 21 at a second end face 1b closer to the connector 6 than the first end face 1a. The twelve dielectric waveguide wires 22 and the dielectric waveguide tube 21 between the first end face 1a and the second end face 1b are mating portions 10 that are mated to the terminal member 5.

The terminal member 5, like the dielectric waveguide tube 21 and the plurality of dielectric waveguide wires 22, is made of fluororesin having a dielectric loss tangent smaller than 1×10⁻³, more specifically, PTFE. The terminal member 5 has a cylindrical portion 51 and a conical portion 52 in one piece, and the cylindrical portion 51 and the conical portion 52 are axially aligned along a central axis line C₅. The cylindrical portion 51 is a cylinder having a constant outer diameter D₅₁ throughout the longitudinal direction. The conical portion 52 is a cone with a gradually decreasing outer diameter D₅₂ toward the tip. The outer diameter D₅₁ of the cylindrical portion 51 is equivalent to the outer diameter D₁ of the dielectric waveguide cable 1. The outer diameter D₅₂ of the conical portion 52 is equal to the outer diameter D₅₁ of the cylindrical portion 51 at the end of the cylindrical portion 51 and gradually decreases as it is axially away from the cylindrical portion 51. The conical angle θ of the conical portion 52 is, for example, from 5° to 15° (5° or more and 15° or less).

The terminal member 5 has a shaft hole 50 centered at the central axis line C₅. The shaft hole 50 comprises a mating portion 501 into which the mating portion 10 of the dielectric waveguide cable 1 is mated, a small diameter portion 502 whose inner diameter is smaller than the mating portion 501, and a tapered portion 503 between the mating portion 501 and the small diameter portion 502. The mating portion 501, the small diameter portion 502, and the tapered portion 503 are aligned along the central axis line C₅ of the terminal member 5, and the small diameter portion 502 is formed closer to the tip of the conical portion 52 than the mating portion 501. The shapes of the mating portion 501, the small diameter portion 502, and the tapered portion 503 in a cross-section perpendicular to the central axis line C₅ of the terminal member 5 are circular, respectively. The inner diameter of the tapered portion 503 gradually decreases from the mating portion 501 side to the small diameter portion 502 side.

The length of the mating portion 501 in the axial direction of the terminal member 5 is equivalent to the length of the mating portion 10 of the dielectric waveguide cable 1. The first end face 1a of the dielectric waveguide cable 1 is placed against the rear end face 5a of the terminal member 5 facing the first end face 1a. The dielectric waveguide cable 1 and the terminal member 5 are fixed together by, for example, additional winding of a tape member of the same material as the binder tape 31 or by a fixing member so that the mating portion 10 of the dielectric waveguide cable 1 does not slip out of the mating portion 501 of the terminal member 5.

The mating portion 501 and the tapered portion 503 are formed in the cylindrical portion 51. The small diameter portion 502 is partially formed at the center of the cylindrical portion 51 and the remaining portion is formed at the center of the conical portion 52. The small diameter portion 502 has a cylindrical hole portion 502a with a constant inner diameter and a reduced diameter portion 502b whose inner diameter decreases toward the tip of the conical portion 52, wherein the cylindrical hole portion 502a is formed at the center of the cylindrical portion 51 and the reduced diameter portion 502b is formed at the center of the conical portion 52. The inner diameter of the cylindrical hole portion 502a is equivalent to the inner diameter of the cavity 20 of the dielectric waveguide tube 21. The inner diameter of the reduced diameter portion 502b is equal to the inner diameter of the cylindrical hole portion 502a at the end on the side of the cylindrical hole portion 502a and gradually decreases as it is axially away from the cylindrical hole portion 502a.

The connector 6 has a main body portion 61 and a mounting portion 62, and the mounting portion 62 is attached to the main body portion 61 by a plurality of bolts 63. The main body portion 61 has a housing hole 610 for accommodating a portion of the cylindrical portion 51 and the conical portion 52 of the terminal member 5. The mounting portion 62 has an insertion hole 620 into which the terminal member 5 is inserted, and a retaining member 64 holding the cylindrical portion 51 of the terminal member 5 is disposed inside the insertion hole 620. The retaining member 64 is made of resin, for example, PTFE.

The dielectric waveguide cable 1 and the terminal member 5 are coaxially connected along the center axis C₁ of the dielectric waveguide cable 1 and the center axis C₅ of the terminal member 5 by fitting the mating portion 10 of the dielectric waveguide cable 1 to the mating portion 501 of the terminal member 5, and the cavity 20 of the dielectric waveguide cable 1 and the shaft hole 50 of the terminal member 5 are connected. Electromagnetic waves propagating through the cavity 20 of the dielectric waveguide tube 21 in the dielectric waveguide cable 1 toward the terminal member 5 are emitted from the cavity 20 at the second end face 1b and incident on the small diameter portion 502 of the shaft hole 50 of the terminal member 5, and enter the coaxial waveguide conversion section 7 through the terminal member 5.

In this first configuration example of the terminal structure, the formation of the reduced diameter portion 502b in the shaft hole 50 of the terminal member 5 suppresses the reflection of electromagnetic waves at the end of the dielectric waveguide cable 1. In other words, if the small diameter portion 502 is not formed in the terminal member 5, the ratio of electromagnetic waves reflected at the end face of the terminal member 5 facing the opening of the cavity 20 becomes large. However, in the first configuration example of the terminal structure, because the small diameter portion 502 having the reduced diameter portion 502b is formed in the terminal member 5, the cross-sectional shape of the cable 1 and the terminal member 5 are continuous. Therefore, the electric and magnetic field distributions of the transmitted electromagnetic waves are almost the same, so the reflection ratio at the end face of the terminal member 5 is suppressed.

FIG. 6A through FIG. 6C are configuration diagrams showing the second example of the terminal structure of the dielectric waveguide cable 1. In FIG. 6A, the dielectric waveguide cable 1, a terminal member 5A, and the connector 6 are shown spaced apart in the axial direction, and in FIG. 6B the dielectric waveguide cable 1, the terminal member 5A, and the connector 6 are shown assembled. FIG. 6C shows a cross-cross-sectional view taken along the line B-B in FIG. 6B. In FIG. 6A through FIG. 6C, members or the like common to those described with reference to FIG. 5A and FIG. 5B are marked with the same reference numerals as those in FIG. 5A and FIG. 5B to omit redundant explanations.

In the second configuration example, the dielectric waveguide cable 1 is connected to the connector 6 via the terminal member 5A. The dielectric waveguide cable 1 and the terminal member 5A are arranged in line in the axial direction so that the center axis C₁ of the dielectric waveguide cable 1 and the center axis C₅ of the terminal member 5A coincide. The terminal member 5A, like the terminal member 5 in the first configuration example, is made of fluororesin such as PTFE and has the cylindrical portion 51 and the conical portion 52 in one piece. In the terminal member 5A, like the mating portion 501 of the shaft hole 50 of the terminal member 5 in the first configuration example, a mating hole 500 is formed into which the mating portion 10 of the dielectric waveguide cable 1 is mated, but a hole corresponding to the small diameter portion 502 is not formed.

A linear dielectric material 23 whose outer diameter is smaller than the inner diameter of the cavity 20 is housed in the cavity 20 at the end of the terminal member 5A side in the core 2 of the dielectric waveguide cable 1. The linear dielectric material 23, like the dielectric waveguide tube 21 and the dielectric waveguide wire 22, is made of a resin having a dielectric tangent smaller than 1×10⁻³, for example, PTFE or FEP. In this example, as shown in FIG. 6C, three linear dielectric materials 23 are arranged in the cavity 20. However, the number of linear dielectric materials 23 is not limited to three, but may be one or two, or even four or more. In other words, at least one linear dielectric material having an outer diameter smaller than the inner diameter of the cavity 20 should be housed.

The length of the linear dielectric material 23 is not particularly limited, but is, for example, from one to ten times the outer diameter of the dielectric waveguide cable 1. The linear dielectric material 23 is arranged in a straight line parallel to the central axis line C₁ in the cavity 20. In the examples shown in FIG. 6A and FIG. 6B, the end face 23a on the terminal member 5A side in the linear dielectric material 23 is at the same position as the second end face 1b, but the end face 23a of the linear dielectric material 23 may be arranged inside the mating portion 10, or a part of the linear dielectric material 23 may protrude from the dielectric waveguide tube 21 toward the terminal member 5A.

The second configuration example of the terminal structure also suppresses reflection of electromagnetic waves at the end of the dielectric waveguide cable 1. In other words, in the second configuration example of the terminal structure, since the shaft hole 50 is not formed in the terminal member 5A, the linear dielectric material 23 is housed in the opening of the cavity 20, which makes the cross-sectional shape of the dielectric waveguide cable 1 and the terminal member 5A continuous and makes the electric field distribution and magnetic field distribution of the propagating electromagnetic waves similar, which suppresses the reflectance. The opposite side of the terminal member 5A of the linear dielectric material 23 housed in the cavity 20 will not have a continuous cross-sectional shape, but since it is located outside the connector 6, the change in the electric and magnetic field distribution of the propagating electromagnetic waves is relatively small, which suppresses the reflectance.

### Summary of the Embodiment

Next, technical ideas understood from the above embodiment, will be described with reference to the reference numerals and the like used in the embodiment. However, each reference numeral in the following description does not limit the constituent elements in the scope of claims to the members and the like specifically shown in the embodiments.

According to the first feature, a dielectric waveguide cable 1 includes a core 2 made from a dielectric material and transmits GHz electromagnetic waves by means of the core 2, wherein a cavity 20 extending along the cable longitudinal direction is formed at the center of the core 2 in a cross-section perpendicular to the cable longitudinal direction.

According to the second feature, in the dielectric waveguide cable 1 described in the first feature, the dielectric material forming the core 2 is a resin whose dielectric tangent at the frequency of electromagnetic waves transmitted by means of the core 2 is smaller than 1×10⁻³.

According to the third feature, in the dielectric waveguide cable 1 described in the second feature, the ratio of the inner diameter Di of the cavity 20 to the cable outer diameter D₁ is from 20% to 40% 20% or more and 40% or less.

According to the fourth feature, in the dielectric waveguide cable 1 described in any of the first to third features, the core 2 has a hollow dielectric waveguide tube 21 in which the cavity 20 is formed, and a plurality of dielectric waveguide wires 22 arranged around the dielectric waveguide tube 21, and wherein the plurality of dielectric waveguide wires 22 are spirally twisted around the periphery of the dielectric waveguide tube 21.

According to the fifth feature, in the dielectric waveguide cable 1 described in the fourth feature, a binder tape 31 is wound around the periphery of the plurality of dielectric waveguide wires 22, and wherein the binder tape 31 is covered by a sheath 32.

According to the sixth feature, a terminal structure of the dielectric waveguide cable 1 configured to transmit GHz-band electromagnetic waves by means of a core 2 made from a dielectric material is configured in such a manner that the terminal member 5 made of a dielectric material having a conical shape 52 and the dielectric waveguide cable 1 are arranged in line so that the central axis C₅ of the terminal member 5 is coincident with the central axis C₁ of the dielectric waveguide cable 1, wherein the dielectric waveguide cable 1 has a cavity 20 extending along the cable longitudinal direction at the center of the core 2 in a cross-section perpendicular to the cable longitudinal direction, wherein the terminal member 5 has a shaft hole 50 having a reduced inner diameter 502b that decreases in diameter toward the tip of the conical portion 52, and wherein the cavity 20 of the dielectric waveguide cable 1 and the shaft hole 50 of the terminal member 5 are in communication with each other.

According to the seventh feature, a terminal structure of the dielectric waveguide cable 1 configured to transmit GHz-band electromagnetic waves by means of the core 2 made from a dielectric material in configured in such a manner that the terminal member 5A and the dielectric waveguide cable 1 are arranged in line so that the central axis C₅ of the terminal member 5A made of a dielectric materials having a conical portion 52 is aligned with the central axis C₁ of the dielectric waveguide cable 1, and the dielectric waveguide cable 1 has a cavity 20 extending along the cable longitudinal direction at the center of the core 2 in a cross-section perpendicular to the cable longitudinal direction, and wherein at least one linear dielectric material 23 having the outer diameter smaller than the inner diameter of the cavity 20, is accommodated in the cavity 20 at the end of the terminal member 5A-side of the core 2.

That is all for the description of the embodiment of the present invention, but the above embodiment does not limit the invention according to the scope of the claims. Also, it should be noted that not all combinations of features are essential to the means for solving problems of the invention.

1. A dielectric waveguide cable, comprising a core composed of a dielectric material and configured to transmit GHz-band electromagnetic waves by means of the core,
wherein a cavity extending along a cable longitudinal direction is formed at a center of the core in a cross-section perpendicular to the cable longitudinal direction.

2. The dielectric waveguide cable, according to claim 1, wherein the dielectric material constituting the core is a resin with a dielectric tangent at a frequency of electromagnetic waves transmitted by means of the core being smaller than 1×10⁻³.

3. The dielectric waveguide cable, according to claim 2, wherein a ratio of a cavity inner diameter to a cable outer diameter is 20% or more and 40% or less.

4. The dielectric waveguide cable according to claim 1, wherein the core comprises a hollow dielectric waveguide tube in which the cavity is formed and a plurality of dielectric waveguide wires arranged around the dielectric waveguide tube, and
wherein the plurality of dielectric waveguide wires are spirally twisted around a circumference of the dielectric waveguide tube.

5. The dielectric waveguide cable, according to claim 4, wherein a binder tape is wound around a circumference of the plurality of dielectric waveguide wires, and
wherein the binder tape is covered by a sheath.

6. A terminal structure of a dielectric waveguide cable configured to transmit GHz-band electromagnetic waves by means of a core composed of a dielectric material, wherein a terminal member and a dielectric waveguide cable are arranged in line so that a central axis of the terminal member composed of a dielectric material having a conical portion coincides with a central axis of the dielectric waveguide cable,
wherein the dielectric waveguide cable includes a cavity extending along a cable longitudinal direction at a center of the core in a cross-section perpendicular to the cable longitudinal direction,
wherein the terminal member includes a shaft hole with a reduced inner diameter that decreases in diameter toward a tip of the conical portion, and
wherein the cavity of the dielectric waveguide cable and the shaft hole of the terminal member are in communication with each other.

7. A terminal structure of dielectric waveguide cable configured to transmit GHz-band electromagnetic waves by a core composed of a dielectric material,
wherein a terminal member and a dielectric waveguide cable are arranged in line so that a central axis of the terminal member composed of a dielectric material having a conical portion, coincides with the central axis of the dielectric waveguide cable,
wherein the dielectric waveguide cable has a cavity extending along a cable longitudinal direction at a center of the core in a cross-section perpendicular to the cable longitudinal direction, and
wherein at least one linear dielectric material having an outer diameter smaller than an inner diameter of the cavity is housed in the cavity at an end of a terminal member-side in the core.
